(19) United States
(12) Patent Application Publication
(10) Pub. No.: US 2026/0241647 A1
(43) Pub. Date: Aug. 20, 2026

(54) METHOD AND APPARATUS FOR MANUFACTURING FIBER-REINFORCED RESIN MATERIAL

(71) Applicant: MAZDA MOTOR CORPORATION, Hiroshima (JP)

(72) Inventors: Hiroki SATO, Aki-gun, Hiroshima (JP); Motonori MORIWAKI, Aki-gun, Hiroshima (JP); Tomoyuki IWAMOTO, Aki-gun, Hiroshima (JP); Kojiro YAMAGUCHI, Aki-gun, Hiroshima (JP); Kouji SATO, Aki-gun, Hiroshima (JP)

(73) Assignee: MAZDA MOTOR CORPORATION, Hiroshima (JP)

(21) Appl. No.: 19/151,928

(22) PCT Filed: Feb. 26, 2024
(86) PCT No.: PCT/JP2024/006822

§ 371 Date: Jul. 29, 2025

(30) Foreign Application Priority Data
Mar. 8, 2023 (JP) 2023-035928

(51) Int. Cl. B29C 70/50; B29C 53/04; B29C 70/20

(52) U.S. Cl. CPC B29C 70/506; B29C 53/043; B29C 70/20

(57) ABSTRACT

A method for manufacturing a fiber-reinforced resin material in which a bundle of reinforcing fibers (2) is impregnated with a resin material (3), comprising: a first step (S11) of forming a first fold line (11a, 11b) extending in a conveying direction on a first-form belt-shaped material (11) in which reinforcing fibers (2) are impregnated with a resin material (3); and a second step (S12) of pressing the first-form belt-shaped material (11) in a width direction; folding the first-form belt-shaped material (11) along the first fold line (11a, 11b); bringing surfaces of the first-form belt-shaped material (11) lying on each other into tight contact with each other; and thereby forming a second-form belt-shaped material (12).

### TECHNICAL FIELD

The technique disclosed herein belongs to the technical field of a method and device for manufacturing a fiber-reinforced resin material.

### BACKGROUND ART

Fiber-reinforced resin materials are utilized in various fields as lightweight and high-strength materials. In general, fiber-reinforced resin materials are manufactured by impregnating bundles of reinforcing fibers with a resin. However, if a resin fails to penetrate between a bundle of fibers and gaps are left therebetween, the properties of the material deteriorate. Traditionally, in order to reduce these gaps, a method of applying high pressure to impregnate fibers with a resin is employed.

For example, Patent Document 1 discloses another method for manufacturing a fiber-reinforced resin material, where reinforcing fibers are conveyed to pass through a powdered thermoplastic resin in an impregnation tank, and then are heated and pressurized by a pair of heating rolls so that the resin and the reinforcing fibers are integrated. Further, Patent Document 2 discloses a method of applying an adhesive agent on a woven-fabric-like web of reinforcing fibers; then cutting the web into pieces; then stacking the webs in multiple layers; and then using a mold to sandwich, harden, and shape the stacked webs.

### CITATION LIST

### Patent Document

Patent Document 1: Japanese Unexamined Patent Publication No. H5-57821

Patent Document 2: Japanese Patent No. 2007-38678

### SUMMARY OF THE INVENTION

### Technical Problem

The method of applying high pressure to impregnate reinforcing fibers with a resin in order to reduce gaps is inefficient in terms of manufacture. The method of Patent Document 1, where reinforcing fibers and a resin form a single layer, is not suitable for manufacture of a member that requires high strength. The method of Patent Document 2, which involves multiple stages of cutting, folding in multiple layers, and curing of a belt-shaped material, is inefficient in terms of manufacture and leads to an increased size of the apparatus.

The technique disclosed herein has been made in view of the foregoing, and an object of the present disclosure is to provide a method and device for manufacturing a fiber-reinforced resin material, where it is possible to efficiently manufacture a fiber-reinforced resin material with high strength.

### Solution to the Problem

In order to achieve the above object, the technique disclosed herein is directed to a method for manufacturing a fiber-reinforced resin material in which a bundle of reinforcing fibers is impregnated with a resin material, including: a first step of forming a first fold line extending in a conveying direction on a first-form belt-shaped material in which reinforcing fibers are impregnated with a resin material; and a second step of pressing the first-form belt-shaped material in a width direction; folding the first-form belt-shaped material along the first fold line; bringing surfaces of the first-form belt-shaped material lying on each other into tight contact with each other; and thereby forming a second-form belt-shaped material.

According to the above configuration, it is possible to fold the belt-shaped material in multiple layers through a series of simple steps, and thus it is possible to form a fiber-reinforced resin material with high strength efficiently in terms of manufacture.

In one embodiment, the method may include a preparation step of forming the first-form belt-shaped material by impregnating the reinforcing fibers aligned in one direction along the conveying direction with the resin material before the first step.

According to the above configuration, by conducting a series of steps to form and fold the first-form belt-shaped material in multiple layers, it is possible to form a fiber-reinforced resin material with high strength efficiently.

In one embodiment, the method may include: a third step of forming a second fold line on the second-form belt-shaped material in a direction different from a direction of the first step after the second step, where the second fold line extends in the conveying direction; and a fourth step of pressing the second-form belt-shaped material in a direction different from a direction of the second step; folding the second-form belt-shaped material along the second fold line; bringing surfaces of the second-form belt-shaped material lying on each other into tight contact with each other; and thereby forming a third-form belt-shaped material.

According to the above configuration, by folding the belt-shaped material in multiple layers multiple times in different directions, it is possible to form a fiber-reinforced resin material with higher strength.

In one embodiment, the method may be configured so that in the first step, a first fold line forming portion formed in a circumferential direction on a first fold line forming roller of which a rotational axis is a first axis orthogonal to the conveying direction rotates to press the first-form belt-shaped material, and thereby forms the first fold line, and in the second step, a first press roller of which a rotational axis is a second axis extending in a direction intersecting the first axis rotates to press the first-form belt-shaped material, and thereby forms the second-form belt-shaped material that is folded in multiple layers in a direction in which the first axis extends.

According to the above configuration, the fold line forming roller that rotates to form fold lines and the press roller that rotates to fold the material in multiple layers are used to make it easier to perform the first step to the second step continuously while transporting the belt-shaped material, and thus it is possible to form a fiber-reinforced resin material with high strength more efficiently.

In one embodiment, the method may be configured so that in the first step, a first fold line forming portion formed in a circumferential direction on a first fold line forming roller of which a rotational axis is a first axis orthogonal to the conveying direction rotates to press the first-form belt-shaped material, and thereby forms the first fold line, and in the second step, a first press roller of which a rotational axis is a second axis extending in a direction intersecting the first axis rotates to press the first-form belt-shaped material, and thereby forms the second-form belt-shaped material that is folded in multiple layers in a direction in which the first axis extends, in the third step, a second fold line forming portion formed in a circumferential direction on a second fold line forming roller of which a rotational axis is a third axis extending in a direction intersecting the first axis rotates to press the second-form belt-shaped material, and thereby forms the second fold line, and in the fourth step, a second press roller of which a rotational axis is a fourth axis extending in a direction intersecting the third axis rotates to press the second-form belt-shaped material, and thereby forms the third-form belt-shaped material that is further folded in multiple layers in a direction in which the third axis extends.

According to the above configuration, the plurality of fold line forming rollers and the plurality of press rollers, where the rotation axis of the fold line forming roller is different in direction from the rotation axis of the press roller, are used to make it easier to perform the first step to the fourth step continuously while transporting the belt-shaped material. Then, by folding the belt-shaped material in multiple layers multiple times in different directions, it is possible to form a fiber-reinforced resin material with higher strength more efficiently.

In one embodiment, the method may be configured so that the fold line forming portion includes a recess and a ridge extending in the conveying direction, and a pair of the fold line forming rollers each including the recess and the ridge sandwich the belt-shaped material and rotate while allowing the recess and the ridge to engage with each other.

According to the above configuration, the pair of fold line forming rollers each including the recess and the ridge make it easier to form the fold lines on the belt-shaped material.

In one embodiment, the method may be configured so that a pair of the press rollers sandwich and press the belt-shaped material from both sides of the fold line, and thereby fold the belt-shaped material along the fold line.

According to the above configuration, the pair of press rollers make it easier to fold the belt-shaped material in multiple layers.

In one embodiment, the method may be configured so that the fold line forming roller includes a plurality of the recesses and a plurality of the ridges provided alternately in a direction in which the rotational axis of the fold line forming roller extends, and forms a belt-shaped material folded in a bellows shape and having a series of mountain-shaped fold lines and valley-shaped fold lines.

According to the above configuration, the plurality of recesses and the plurality of ridges are used to form the belt-shaped material in a bellows shape. That is, the belt-shaped material is folded in multiple layer through a single folding process, and thus it is possible to form a fiber-reinforced resin material with higher strength more efficiently.

The technique disclosed herein is directed to a device for manufacturing a fiber-reinforced resin material in which a bundle of reinforcing fibers is impregnated with a resin material, including: a conveying device conveying in a conveying direction a first-form belt-shaped material in which reinforcing fibers aligned in one direction along the conveying direction are impregnated with a resin material; a first fold line forming member that includes a first fold line forming portion extending in the conveying direction and that presses the first fold line forming portion onto the first-form belt-shaped material; and a first press member arranged downstream of the first fold line forming member in the conveying direction; and pressing the first-form belt-shaped material in a direction different from a direction of the first fold line forming member, thereby forming a second-form belt-shaped material that is folded in multiple layers in a direction intersecting the conveying direction.

According to the above configuration, it is possible to fold the belt-shaped material in multiple layers through a series of steps using simple components, and thus it is possible to form a fiber-reinforced resin material with high strength efficiently in terms of manufacture.

In one embodiment, the device may include: a second fold line forming member arranged downstream of the first press member in the conveying direction; including a second fold line forming portion extending in the conveying direction; and pressing the second fold line forming portion onto the second-form belt-shaped material in a direction different from a direction of the first fold line forming member; and a second press member arranged downstream of the second fold line forming member in the conveying direction; and pressing the second-form belt-shaped material in a direction different from a direction of the second fold line forming member, thereby forming a third-form belt-shaped material that is further folded in multiple layers in a direction intersecting the conveying direction.

According to the above configuration, by folding the belt-shaped material in multiple layers twice in different directions, it is possible to form a fiber-reinforced resin material with higher strength.

In one embodiment, the device may be configured so that the first fold line forming member is a first fold line forming roller of which a rotational axis is a first axis orthogonal to the conveying direction, the first fold line forming portion is formed in a circumferential direction on the first fold line forming roller, and includes a recess and a ridge formed alternately in a direction of the first axis, the first fold line forming roller rotates to press the recess and the ridge onto the first-form belt-shaped material, and thereby forms the first fold line on the first-form belt-shaped material, the first press member is a first press roller of which a rotational axis is a second axis extending in a direction intersecting the first axis, and the first press roller presses the first-form belt-shaped material; folds the first-form belt-shaped material along the first fold line; brings surfaces of the first-form belt-shaped material lying on each other into tight contact with each other; and thereby forms a second-form belt-shaped material.

According to the above configuration, the fold line forming roller that rotates to form fold lines and the press roller that rotates to fold the material in multiple layers are used to make it easier to perform the first step to the second step continuously, and thus it is possible to form a fiber-reinforced resin material with high strength more efficiently.

In one embodiment, the device may be configured so that the first fold line forming member is a first fold line forming roller of which a rotational axis is a first axis orthogonal to the conveying direction, the first fold line forming portion is formed in a circumferential direction on the first fold line forming roller, and includes a recess and a ridge formed alternately in a direction of the first axis, the first fold line forming roller rotates to press the recess and the ridge onto the first-form belt-shaped material, and thereby forms the first fold line on the first-form belt-shaped material, the first press member is a first press roller of which a rotational axis is a second axis extending in a direction intersecting the first axis, the first press roller presses the first-form belt-shaped material; folds the first-form belt-shaped material along the first fold line; brings surfaces of the first-form belt-shaped material lying on each other into tight contact with each other; and thereby form a second-form belt-shaped material, the second fold line forming member is a second fold line forming roller of which a rotational axis is a third axis extending in a direction intersecting the first axis, the second fold line forming portion is formed in a circumferential direction on the second fold line forming roller, and includes a recess and a ridge formed alternately in a direction of the third axis, the second fold line forming roller rotates to press the recess and the ridge onto the second-form belt-shaped material, and thereby forms the second fold line on the second-form belt-shaped material, the second press member is a second press roller of which a rotational axis is a fourth axis extending in a direction intersecting the third axis, and the second press roller presses the second-form belt-shaped material; folds the second-form belt-shaped material along the second fold line; brings surfaces of the second-form belt-shaped material lying on each other into tight contact with each other; and thereby form a third-form belt-shaped material.

According to the above configuration, the plurality of fold line forming rollers and the plurality of press rollers, where the rotation axis of the fold line forming roller is different in direction from the rotation axis of the press roller, are used to make it easier to form the fold lines and fold the material in multiple layers multiple times continuously. Then, by folding the belt-shaped material in multiple layers multiple times in different directions, it is possible to form a fiber-reinforced resin material with higher strength more efficiently.

### Advantages of the Invention

As described above, according to the method and device for manufacturing a fiber-reinforced resin material disclosed herein, it is possible to efficiently manufacture a fiber-reinforced resin material with high strength.

### BRIEF DESCRIPTION OF DRAWINGS

FIG. 1 is a schematic plan view of an exemplary device for manufacturing a fiber-reinforced resin material.

FIG. 2 is a schematic front view of the exemplary device for manufacturing a fiber-reinforced resin material.

FIG. 3 is a schematic perspective view of the exemplary device for manufacturing a fiber-reinforced resin material.

FIG. 4 is a cross-sectional view taken along line IV-IV in FIG. 1.

FIG. 5 is a cross-sectional view taken along line V-V in FIG. 1.

FIG. 6 is a cross-sectional view taken along line VI-VI in FIG. 1.

FIG. 7 is a cross-sectional view taken along line VII-VII in FIG. 1.

FIG. 8 is a sectional view taken along line VIII-VIII in FIG. 1.

FIG. 9 is a flowchart showing an example of the method for manufacturing a fiber-reinforced resin material.

### DESCRIPTION OF EMBODIMENTS

Exemplary embodiments will be described in detail below with reference to the drawings. The following description employs the terms of direction such as right and left, top and bottom, and front and back, but these terms of direction are not intended to limit the arrangement of components and the driving direction of a manufacturing device.

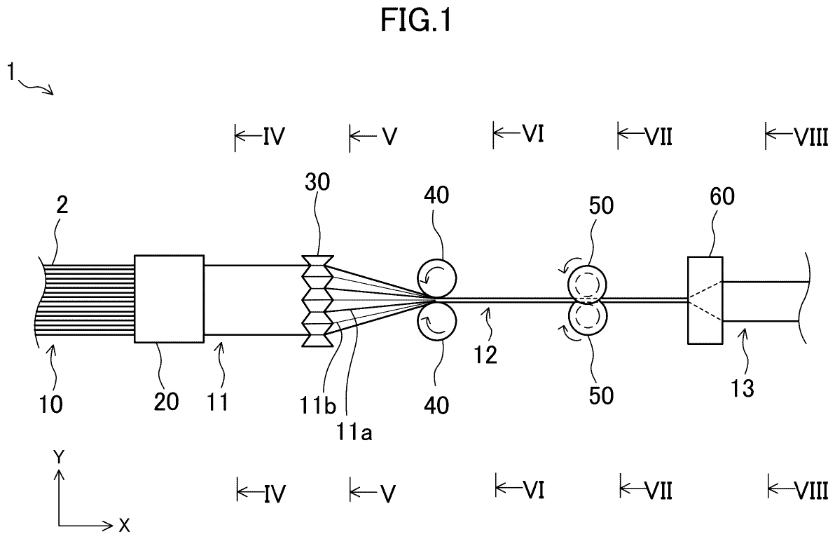

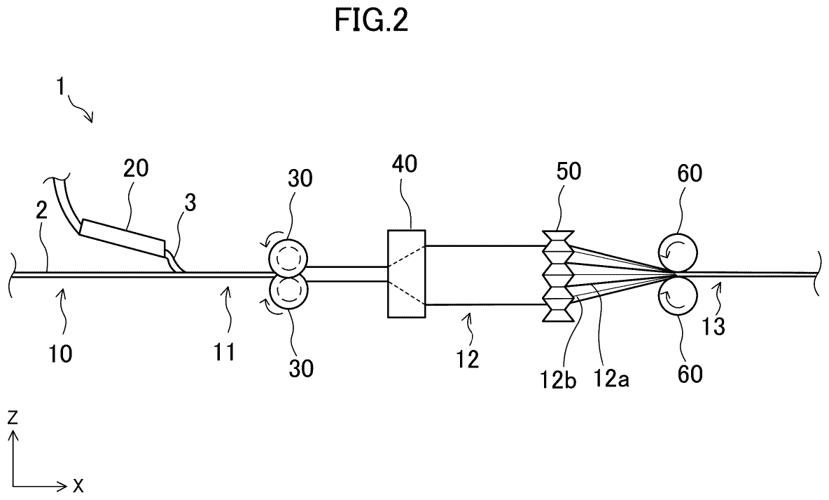

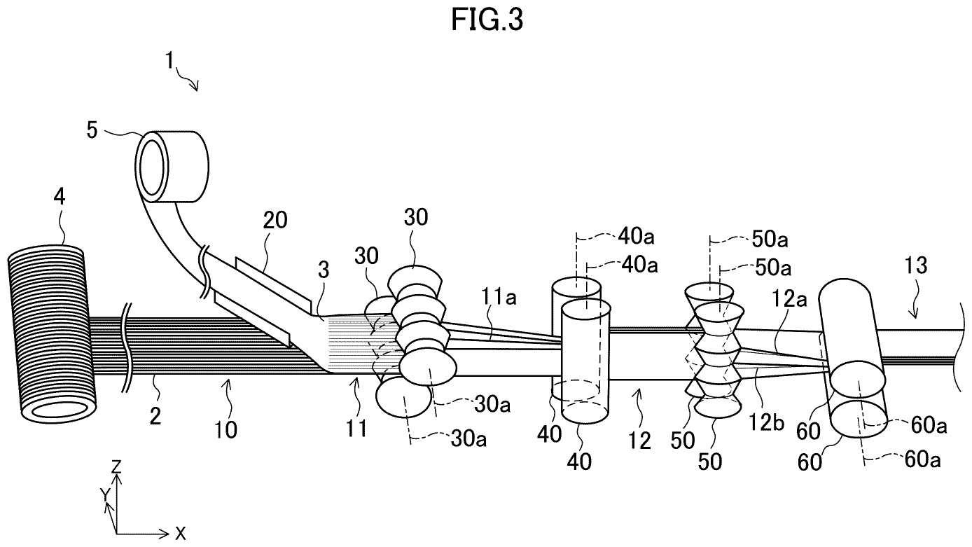

FIG. 1 is a schematic plan view of an exemplary manufacturing device 1 for a fiber-reinforced resin material. FIG. 2 is a front view of the same. FIG. 3 is a perspective view of the same. X, Y, and Z in the figures represent the X-axis direction, the Y-axis direction, and the Z-axis direction. In the following embodiments, the X-axis direction represents the right-left direction, the Y-axis direction represents the front-back direction, and the Z-axis direction represents the top-bottom direction. These directions may depend on the embodiment, and are not intended to limit the driving direction of the manufacturing device. In the following description, the upstream side and the downstream side refer to the upstream side and the downstream side in the conveying direction.

The manufacturing device 1 is a device for manufacturing a fiber-reinforced resin material in which a bundle of reinforcing fibers 2 is impregnated with a resin material 3. The manufacturing device 1 is a device that folds a belt-shaped material in a bellows shape along the conveying direction multiple times in which the bundle of reinforcing fibers 2 is impregnated with the resin material 3. The manufacturing device 1 includes a conveying device (not shown), first fold line forming members 30, first press members 40, second fold line forming members 50, and second press members 60.

The reinforcing fibers 2 are not particularly limited as long as they can be used for a fiber-reinforced resin material, and examples include carbon fibers, glass fibers, or fibers made from acrylic, bamboo, or hemp as raw materials. The diameter of the reinforcing fiber 2 is from 1 to 350 μm, for example, and preferably from 1 to 50 μm. The reinforcing fibers 2 may be of any color. The reinforcing fiber may have any hardness as long as it can be reeled, but preferably has a minimum bending radius of 1 mm or more, for example.

The resin material 3 is not particularly limited as long as it can be used for a fiber-reinforced resin material, and may be either a thermosetting resin or a thermoplastic resin. A thermosetting resin may be used alone, a thermoplastic resin may be used alone, or a thermosetting resin and a thermoplastic resin may be used together. Colorant and other additives may be added to the resin material.

Examples of the thermosetting resin include epoxy resins, vinyl ester resins, phenol resins, acrylate resins, phenoxy resins, urethane resins, and cyanate resins. The thermosetting resin may be one type of thermosetting resin, or may be combination of two or more types of thermosetting resin. The thermosetting resin preferably has a viscosity of 100 to 10,000 Pa·sec.

Examples of the thermoplastic resin include polypropylene, polyamide, polyester-based resins, styrene-based resins, fluororesins, and olefin-based resins. The thermoplastic resin may be one type of thermoplastic resin, or may be combination of two or more types of thermoplastic resin. The thermoplastic resin preferably has a melt flow rate (MFR) of 5 to 60 g/10 min.

The conveying device conveys in the conveying direction the belt-shaped material in which the reinforcing fibers 2 aligned in one direction along the conveying direction are impregnated with the resin material 3. In this embodiment, the conveying direction is the X-axis direction, and FIG. 1 to FIG. 3 show that the conveying device continuously conveys the belt-shaped material from left to right in the drawings. Although not shown, the conveying device may be a typical conveying device that conveys a belt-shaped or sheet-shaped material in a predetermined direction. For example, the conveying device may be a reeling device that is arranged at the most downstream side in the conveying direction and that rotates to reel a belt-shaped or sheet-shaped material.

In this embodiment, a fiber reeling-out roll 4 and a resin reeling-out roll 5 are arranged at the most upstream side in the conveying direction. The fiber reeling-out roll 4 reels out the aligned fibers 10 toward the downstream side, where the aligned fibers 10 are the thread-like reinforcing fibers 2 aligned in one direction at predetermined intervals. The resin reeling-out roll 5 reels out the sheet-shaped viscous resin material 3 toward the downstream side.

The fiber reeling-out roll 4 and the resin reeling-out roll 5 are driven by the conveying device, and reel out the aligned fibers 10 and the resin material 3 in the conveying direction. In this embodiment, the fiber reeling-out roll 4 reels out in a substantially horizontal direction the aligned fibers 10, namely the plurality of reinforcing fibers 2 aligned in the Y-axis direction. A guide 20 is provided downstream of the resin reeling-out roll 5. The guide 20 guides so that the resin material 3 is conveyed along the aligned fibers 10 and is laid on the aligned fibers 10.

While conveying the aligned fibers 10, the manufacturing device 1 make use of the guide 20 in order to lay the viscous resin material 3 on the aligned fibers 10. By the resin material 3 being laid on the aligned fibers 10, the reinforcing fibers 2 are impregnated with the resin material 3 and form a belt-shaped material. The belt-shaped material in this state is referred to as the first-form belt-shaped material 11.

If the resin material 3 is a thermoplastic resin, a heating roller that heats the first-form belt-shaped material 11 may be provided in order to melt the resin material 3 and hold its viscosity low so that the resin material 3 can penetrate between the reinforcing fibers 2 without leaving gaps. If the reinforcing fibers 2 are electrically conductive fibers and the resin material 3 is a thermoplastic resin, the reinforcing fibers 2 may be energized when being conveyed in order to heat and melt the resin material 3 on the reinforcing fibers 2 so that the resin material 3 can penetrate between the reinforcing fibers 2.

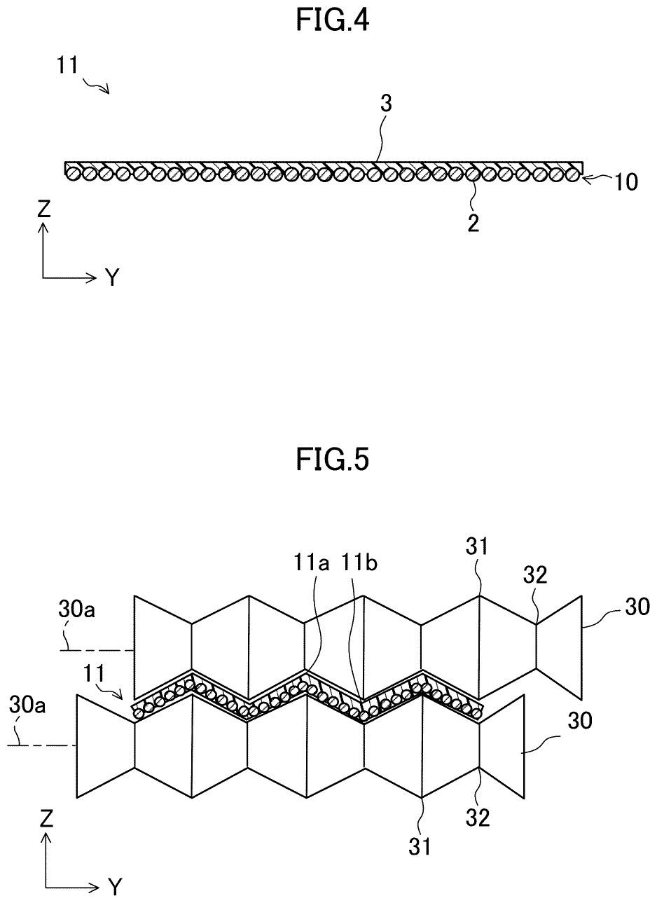

FIG. 4 is an end view taken along line IV-IV in FIG. 1 and shows a cross section of the first-form belt-shaped material 11. As shown in FIG. 4, in the first-form belt-shaped material 11, the plurality of reinforcing fibers 2 are aligned in a row in the Y-axis direction, and are impregnated and thus integrated with the resin material 3.

The first fold line forming members 30 are arranged downstream of the guide 20. The first fold line forming member 30 is a first fold line forming roller of which the rotational axis is a first axis 30a orthogonal to the conveying direction. In this embodiment, the first axis 30a extends in the Y-axis direction, and the pair of first fold line forming rollers 30 and 30, each of which rotates in the counter direction of the other, are arranged in the Z-axis direction to sandwich the first-form belt-shaped material 11.

The first fold line forming roller 30 includes fold line forming portions 31 and 32 that extend in the conveying direction. By pressing the fold line forming portions 31 and 32 onto the first-form belt-shaped material 11, the first fold line forming rollers 30 form first fold lines 11a and 11b extending in the conveying direction on the first-form belt-shaped material 11.

FIG. 5 is a cross-sectional view taken along line V-V in FIG. 1 and shows the pair of first fold line forming rollers 30 and 30 and the first-form belt-shaped material 11 on which the first fold lines 11a and 11b are formed. As shown in FIG. 5, the pair of first fold line forming rollers 30 and 30 each include fold line forming portions 31 and 32 that extend in the circumferential direction along the conveying direction. Specifically, the fold line forming portions 31 and 32 are ridges 31 and recesses 32. The plurality of ridges 31 and the plurality of recesses 32 are alternately formed in the Y-axis direction. In this embodiment, the ridge 31 is a protrusion protruding in the outward direction from the first axis 30a; formed around in the circumferential direction; and having a V-shape and an inverted V-shape when viewed in the conveying direction as shown in FIG. 5. The recess is a groove recessed in the inward direction toward the first axis 30a; formed around in the circumferential direction; and having an inverted V-shape and a V-shape when viewed in the conveying direction as shown in FIG. 5. The pair of first fold line forming rollers 30 and 30 are spaced apart so that the first-form belt-shaped material 11 can pass therebetween, and that their ridges 31 and recesses 32 engage with each other.

By sandwiching the first-form belt-shaped material 11 from both top and bottom, the pair of first fold line forming rollers 30 and 30 press the ridges 31 and the recesses 32 onto the first-form belt-shaped material 11. By sandwiching the first-form belt-shaped material 11 and rotating to allow their ridges 31 and recesses 32 to engage with each other, the pair of first fold line forming rollers 30 and 30 form mountain-shaped first fold lines 11a and valley-shaped first fold lines 11b on the first-form belt-shaped material 11 that is originally flat. The plurality of mountain-shaped first fold lines 11a and the plurality of valley-shaped first fold lines 11b are alternately formed in the Y-axis direction, so that the first-form belt-shaped material 11 is formed into a bellows shape. In FIG. 5, the first-form belt-shaped material 11 is integrated in one piece, but the first-form belt-shaped material 11 may be divided at the first fold lines 11a and 11b.

The first press members 40 are arranged downstream of the first fold line forming rollers 30. By pressing the first-form belt-shaped material 11 in a direction different from the direction of the first fold line forming rollers 30, the first press members 40 form a second-form belt-shaped material 12 that is folded in multiple layers in a direction intersecting the conveying direction. The first press member 40 is a first press roller of which the rotational axis is a second axis 40a extending in a direction intersecting the first axis 30a. The first press roller 40 is a cylindrical member. In this embodiment, the second axis 40a extends in the Z-axis direction orthogonal to the Y-axis direction and the conveying direction, and the pair of first press rollers 40 and 40, each of which rotates in the counter direction of the other, are arranged in the Y-axis direction to sandwich the first-form belt-shaped material 11. The pair of first press rollers 40 and 40 are spaced apart so that the second-form belt-shaped material 12 can pass therebetween.

The first press rollers 40 press the first-form belt-shaped material 11 from both sides in the width direction, or the Y-axis direction, where the first-form belt-shaped material 11 is folded in a bellows shape and has the first fold lines 11a and 11b. By pressing the first-form belt-shaped material 11 from both sides of the first fold lines 11a and 11b, the first press rollers 40 fold the first-form belt-shaped material 11 along the first fold lines 11a and 11b; bring the surfaces of the first-form belt-shaped material 11 lying on each other into tight contact with each other; and thereby form the second-form belt-shaped material 12.

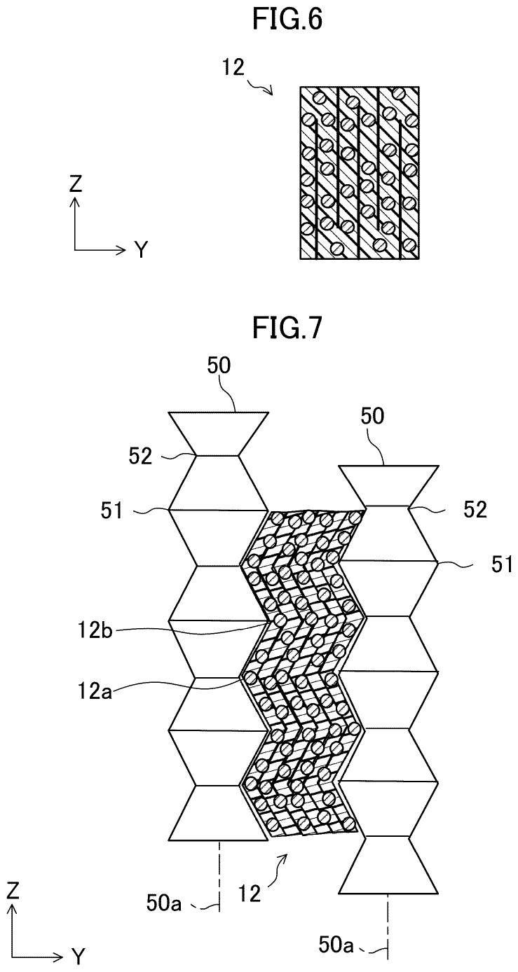

FIG. 6 is an end view taken along line VI-VI in FIG. 1 and shows a cross section of the second-form belt-shaped material. As shown in FIG. 6, the first-form belt-shaped material 11 folded in a bellows shape and having the plurality of first fold lines 11a and 11b in the Y-axis direction is pressed from both sides in the Y-axis direction, so that the second-form belt-shaped material 12 that is folded in multiple layers in the Y-axis direction is formed.

The second fold line forming members 50 are arranged downstream of the first press rollers 40. The second fold line forming member 50 is a second fold line forming roller of which the rotational axis is a third axis 50a extending in a direction intersecting the first axis 30a. In this embodiment, the second fold line forming roller 50 includes the third axis 50a extending in the Z-axis direction. The pair of second fold line forming rollers 50 and 50, each of which rotates in the counter direction of the other, are arranged in the Y-axis direction to sandwich the second-form belt-shaped material 12.

The second fold line forming roller 50 includes second fold line forming portions 51 and 52 that extend in the conveying direction. By pressing the second fold line forming portions 51 and 52 onto the second-form belt-shaped material 12 in a direction different from the direction of the first fold line forming portions 31 and 32, the second fold line forming rollers 50 form second fold lines 12a and 12b extending in the conveying direction on the second-form belt-shaped material 12.

FIG. 7 is a cross-sectional view taken along line VII-VII in FIG. 1 and shows the pair of second fold line forming rollers 50 and 50 and the second-form belt-shaped material 12 on which the second fold lines 12a and 12b are formed. As shown in FIG. 7, the second fold line forming roller 50 includes the fold line forming portions 51 and 52 that extend in the circumferential direction along the conveying direction. Specifically, the fold line forming portions 51 and 52 are ridges 51 and recesses 52. The plurality of ridges 51 and the plurality of recesses 52 are alternately formed in the Z-axis direction. In this embodiment, the ridge 51 is a protrusion protruding in the outward direction from the third axis 50a; formed around in the circumferential direction; and having a V-shape and an inverted V-shape when viewed in the conveying direction as shown in FIG. 7. The recess 52 is a groove recessed in the inward direction toward the third axis 50a; formed around in the circumferential direction; and having an inverted V-shape and a V-shape when viewed in the conveying direction as shown in FIG. 7. The pair of second fold line forming rollers 50 and 50 are spaced apart so that the second-form belt-shaped material 12 can pass therebetween, and that their ridges 51 and recesses 52 engage with each other.

By sandwiching the second-form belt-shaped material 12 from both front and back, the pair of second fold line forming rollers 50 and 50 press the ridges 51 and the recesses 52 onto the second-form belt-shaped material 12. By sandwiching the second-form belt-shaped material 12 and rotating to allow their ridges 51 and recesses 52 to engage with each other, the pair of second fold line forming rollers 50 form mountain-shaped second fold lines 12a and valley-shaped second fold lines 12b on the second-form belt-shaped material 12 that is originally flat. The plurality of mountain-shaped second fold lines 12a and the plurality of valley-shaped second fold lines 12b are alternately formed in the Z-axis direction, so that the second-form belt-shaped material 12 is formed into a bellows shape.

The second press members 60 are arranged downstream of the second fold line forming rollers 50. By pressing the second-form belt-shaped material 12 in a direction different from the direction of the second fold line forming rollers 50, the second press members 60 form a third-form belt-shaped material 13 that is folded in multiple layers in a direction intersecting the conveying direction. The second press member 60 is a second press roller of which the rotational axis is a fourth axis 60a extending in a direction intersecting the third axis 50a. The second press roller 60 is a cylindrical member. In this embodiment, the fourth axis 60a extends in the Y-axis direction orthogonal to the Z-axis direction and the conveying direction. The pair of second press rollers 60 and 60, each of which rotates in the counter direction of the other, are arranged in the Z-axis direction to sandwich the second-form belt-shaped material 12. The pair of second press rollers 60 and 60 are spaced apart so that the second-form belt-shaped material 12 can pass therebetween.

The second press rollers 60 press the second-form belt-shaped material 12 from both sides in the width direction, or the Z-axis direction, where the second-form belt-shaped material 12 is folded in a bellows shape and has the second fold lines 12a and 12b. By pressing the second-form belt-shaped material 12 from both sides of the second fold lines 12a and 12b, the second press rollers 60 fold the second-form belt-shaped material 12 along the second fold lines 12a and 12b; bring the surfaces of the second-form belt-shaped material 12 lying on each other into tight contact with each other; and thereby form the third-form belt-shaped material 13.

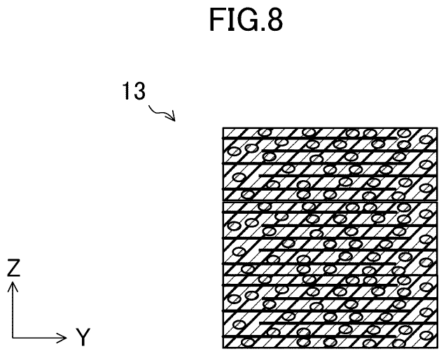

FIG. 8 is an end view taken along line VIII-VIII in FIG. 1 and shows a cross section of the third-form belt-shaped material. As shown in FIG. 8, the second-form belt-shaped material 12 folded in a bellows shape and having the plurality of second fold lines 12a and 12b in the Z-axis direction is pressed from both sides in the Z-axis direction, so that the third-form belt-shaped material 13 that is further folded in multiple layers in the Z-axis direction is formed.

A reeling device (not shown) is arranged downstream of the second press rollers 60. The reeling device rotates to reel the third-form belt-shaped material 13.

According to this embodiment, it is possible to conduct the continuous processing without cutting operation: namely, reel out the reinforcing fibers 2 as the aligned fibers 10 from the fiber reeling-out roll 4; then fold them in multiple layers multiple times into the first-form belt-shaped material 11, the second-form belt-shaped material 12, and the third-form belt-shaped material 13 in sequence; and then reel the resulting material using the reeling device.

In this embodiment, the pair of fold line forming rollers 30 and 30, 50 and 50 are arranged on both sides to sandwich the belt-shaped material, and each of the rollers is configured to rotate, but the configuration is not limited thereto. The pair of fold line forming rollers do not necessarily need to be employed, and one single roller may be employed as long as it can press the fold line forming member onto the belt-shaped material to form fold lines. In this embodiment, the pairs of press rollers 40 and 40, 60 and 60 are arranged on both sides to sandwich the belt-shaped material, and each is configured to rotate. However, the pair of press rollers do not necessarily need to be employed, and one single roller may be employed as long as it can press the belt-shaped material. Further, in this embodiment, the first fold line forming members 30, the first press members 40, the second fold line forming members 50, and the second press members 60 are used to fold the belt-shaped material in multiple layers twice in different directions, but the number of fold line forming members and the number of press members are not limited. One fold line forming member and one press member may be provided to fold the belt-shaped material once. Further, three or more fold line forming members and three or more press members may be provided to fold the belt-shaped material three or more times.

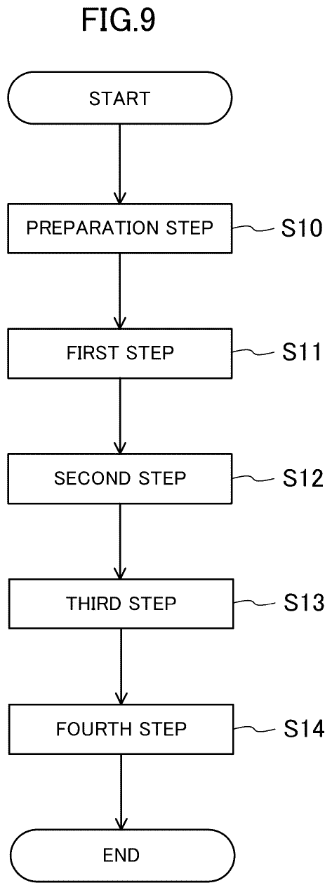

FIG. 9 is a flowchart showing the method for manufacturing a fiber-reinforced resin material using the manufacturing device 1 of the present disclosure. The method for manufacturing a fiber-reinforced resin material according to the present disclosure includes a preparation step S10, a first step S11, a second step S12, a third step S13, and a fourth step S14.

The preparation step S10 is a step of forming the first-form belt-shaped material 11 by impregnating the reinforcing fibers 2 aligned in one direction along the conveying direction with the resin material 3.

The first step S11 is a step of forming first fold lines 11a and 11b extending in the conveying direction on the first-form belt-shaped material 11. In the first step S11, the first fold line forming roller 30 of which the rotational axis is the first axis 30a rotates to press the first fold line forming portions 31 and 32 onto the first-form belt-shaped material 11, where the first fold line forming portions 31 and 32 are formed in the circumferential direction.

The second step S12 is a step of pressing the first-form belt-shaped material 11 in the width direction; folding the first-form belt-shaped material 11 along the first fold lines 11a and 11b; bringing the surfaces of the first-form belt-shaped material 11 lying on each other into tight contact with each other; and thereby forming the second-form belt-shaped material 12. In the second step S12, the first press roller 40 of which the rotational axis is the second axis 40a rotates to press the first-form belt-shaped material 11, and thereby forms the second-form belt-shaped material 12 that is folded in multiple layers in the direction in which the first axis 30a extends.

The third step S13 is a step of forming the second fold lines 12a and 12b on the second-form belt-shaped material 12 in a direction different from the direction of the first step S11, where the second fold lines 12a and 12b extend in the conveying direction. In the third step S13, the second fold line forming roller 50 of which the rotational axis is the third axis 50a rotates to press the fold line forming portions 51 and 52 in the circumferential direction onto the second-form belt-shaped material 12 and thereby forms the second fold lines 12a and 12b.

The fourth step S14 is a step of pressing the second-form belt-shaped material 12 in a direction different from the direction of the second step S12; folding the second-form belt-shaped material 12 along the second fold lines 12a and 12b; bringing the surfaces of the second-form belt-shaped material 12 lying on each other into tight contact with each other; and thereby forming the third-form belt-shaped material 13. In the fourth step, the second press roller 60 of which the rotational axis is the fourth axis 60a rotates to press the second-form belt-shaped material 12, and thereby forms the third-form belt-shaped material 13 that is further folded in multiple layers in the direction in which the third axis 50a extends.

According to the above method and device for manufacturing a fiber-reinforced resin material, it is possible to fold the belt-shaped material in multiple layers through a series of simple steps, and by repeating the steps multiple times, it is possible to form a fiber-reinforced resin material with high strength efficiently in terms of manufacture. In addition, it is possible to fold the reinforcing fibers multiple times without cutting them. Thus, for recycling of the fiber-reinforced resin material manufactured by the above method and device, it is easy to release the reinforcing fibers by melting the resin material, and then it is possible to retrieve long reinforcing fibers. Thus, it is possible to achieve significantly high recyclability.

The embodiments described above are merely examples in nature, and the scope of the present disclosure should not be interpreted in a limited manner. The scope of the present disclosure is defined by the appended claims, and all variations and changes belonging to a range equivalent to the range of the claims are within the scope of the present disclosure.

### INDUSTRIAL APPLICABILITY

The technique disclosed herein is advantageously applicable to a manufacturing method and manufacturing device for a fiber-reinforced resin material.

### DESCRIPTION OF REFERENCE CHARACTERS

1 Manufacturing Device
2 Reinforcing Fiber
3 Resin Material
4 Fiber Reeling-out Roll
5 Resin Reeling-out Roll
10 Aligned Fiber
11 First-Form Belt-Shaped Material
11a, 11b First Fold Line
12 Second-Form Belt-Shaped Material
12a, 12bSecond Fold Line
13 Third-Form Belt-Shaped Material
20 Guide
30 First Fold Line Forming Roller (First Fold Line Forming Member)
30a First Axis
31 Ridge (First Fold Line Forming Portion)
32 Recess (First Fold Line Forming Portion)
40 First Press Roller (First Press Member)
40a Second Axis
50 Second Fold Line Forming Roller (Second Fold Line Forming Member)
50a Third Axis
51 Ridge (Second Fold Line Forming Portion)
52 Recess (Second Fold Line Forming Portion)
60 Second Press Roller (Second Press Member)
60a Fourth Axis
S10 Preparation Step
S11 First Step
S12 Second Step
S13 Third Step
S14 Fourth Step

1. A method for manufacturing a fiber-reinforced resin material in which a bundle of reinforcing fibers is impregnated with a resin material, comprising:
a first step of forming a first fold line extending in a conveying direction on a first-form belt-shaped material in which reinforcing fibers are impregnated with a resin material; and
a second step of pressing the first-form belt-shaped material in a width direction; folding the first-form belt-shaped material along the first fold line; bringing surfaces of the first-form belt-shaped material lying on each other into tight contact with each other; and
thereby forming a second-form belt-shaped material.

2. The method of claim 1, comprising:
a preparation step of forming the first-form belt-shaped material by impregnating the reinforcing fibers aligned in one direction along the conveying direction with the resin material before the first step.

3. The manufacturing method of claim 2, comprising:
a third step of forming a second fold line on the second-form belt-shaped material in a direction different from a direction of the first step after the second step, where the second fold line extends in the conveying direction; and
a fourth step of pressing the second-form belt-shaped material in a direction different from a direction of the second step; folding the second-form belt-shaped material along the second fold line; bringing surfaces of the second-form belt-shaped material lying on each other into tight contact with each other; and thereby forming a third-form belt-shaped material.

4. The method of claim 2, wherein
in the first step, a first fold line forming portion formed in a circumferential direction on a first fold line forming roller of which a rotational axis is a first axis orthogonal to the conveying direction rotates to press the first-form belt-shaped material, and thereby forms the first fold line, and
in the second step, a first press roller of which a rotational axis is a second axis extending in a direction intersecting the first axis rotates to press the first-form belt-shaped material, and thereby forms the second-form belt-shaped material that is folded in multiple layers in a direction in which the first axis extends.

5. The method of claim 3, wherein
in the first step, a first fold line forming portion formed in a circumferential direction on a first fold line forming roller of which a rotational axis is a first axis orthogonal to the conveying direction rotates to press the first-form belt-shaped material, and thereby forms the first fold line, and
in the second step, a first press roller of which a rotational axis is a second axis extending in a direction intersecting the first axis rotates to press the first-form belt-shaped material, and thereby forms the second-form belt-shaped material that is folded in multiple layers in a direction in which the first axis extends,
in the third step, a second fold line forming portion formed in a circumferential direction on a second fold line forming roller of which a rotational axis is a third axis extending in a direction intersecting the first axis rotates to press the second-form belt-shaped material, and thereby forms the second fold line, and
in the fourth step, a second press roller of which a rotational axis is a fourth axis extending in a direction intersecting the third axis rotates to press the second-form belt-shaped material, and thereby forms the third-form belt-shaped material that is further folded in multiple layers in a direction in which the third axis extends.

6. The method of claim 4, wherein
the fold line forming portion includes a recess and a ridge extending in the conveying direction, and a pair of the fold line forming rollers each including the recess and the ridge sandwich the belt-shaped material and rotate while allowing the recess and the ridge to engage with each other.

7. The method of claim 6, wherein
a pair of the press rollers sandwich and press the belt-shaped material from both sides of the fold line, and thereby fold the belt-shaped material along the fold line.

8. The method of claim 7, wherein
the fold line forming roller includes a plurality of the recesses and a plurality of the ridges provided alternately in a direction in which the rotational axis of the fold line forming roller extends, and forms a belt-shaped material folded in a bellows shape and having a series of mountain-shaped fold lines and valley-shaped fold lines.

9. A device for manufacturing a fiber-reinforced resin material in which a bundle of reinforcing fibers is impregnated with a resin material, comprising:
a conveying device conveying in a conveying direction a first-form belt-shaped material in which reinforcing fibers aligned in one direction along the conveying direction are impregnated with a resin material;
a first fold line forming member that includes a first fold line forming portion extending in the conveying direction and that presses the first fold line forming portion onto the first-form belt-shaped material; and
a first press member arranged downstream of the first fold line forming member in the conveying direction; and pressing the first-form belt-shaped material in a direction different from a direction of the first fold line forming member, thereby forming a second-form belt-shaped material that is folded in multiple layers in a direction intersecting the conveying direction.

10. The device of claim 9, wherein
a second fold line forming member arranged downstream of the first press member in the conveying direction; including a second fold line forming portion extending in the conveying direction; and pressing the second fold line forming portion onto the second-form belt-shaped material in a direction different from a direction of the first fold line forming member; and
a second press member arranged downstream of the second fold line forming member in the conveying direction; and pressing the second-form belt-shaped material in a direction different from a direction of the second fold line forming member, thereby forming a third-form belt-shaped material that is further folded in multiple layers in a direction intersecting the conveying direction.

11. The device of claim 9, wherein
the first fold line forming member is a first fold line forming roller of which a rotational axis is a first axis orthogonal to the conveying direction,
the first fold line forming portion is formed in a circumferential direction on the first fold line forming roller, and includes a recess and a ridge formed alternately in a direction of the first axis,
the first fold line forming roller rotates to press the recess and the ridge onto the first-form belt-shaped material, and thereby forms the first fold line on the first-form belt-shaped material,
the first press member is a first press roller of which a rotational axis is a second axis extending in a direction intersecting the first axis, and
the first press roller presses the first-form belt-shaped material; folds the first-form belt-shaped material along the first fold line; brings surfaces of the first-form belt-shaped material lying on each other into tight contact with each other; and thereby forms a second-form belt-shaped material.

12. The device of claim 10, wherein
the first fold line forming member is a first fold line forming roller of which a rotational axis is a first axis orthogonal to the conveying direction,
the first fold line forming portion is formed in a circumferential direction on the first fold line forming roller, and includes a recess and a ridge formed alternately in a direction of the first axis,
the first fold line forming roller rotates to press the recess and the ridge onto the first-form belt-shaped material, and thereby forms the first fold line on the first-form belt-shaped material,
the first press member is a first press roller of which a rotational axis is a second axis extending in a direction intersecting the first axis,
the first press roller presses the first-form belt-shaped material; folds the first-form belt-shaped material along the first fold line; brings surfaces of the first-form belt-shaped material lying on each other into tight contact with each other; and thereby form a second-form belt-shaped material,
the second fold line forming member is a second fold line forming roller of which a rotational axis is a third axis extending in a direction intersecting the first axis,
the second fold line forming portion is formed in a circumferential direction on the second fold line forming roller, and includes a recess and a ridge formed alternately in a direction of the third axis,
the second fold line forming roller rotates to press the recess and the ridge onto the second-form belt-shaped material, and thereby forms the second fold line on the second-form belt-shaped material,
the second press member is a second press roller of which a rotational axis is a fourth axis extending in a direction intersecting the third axis, and
the second press roller presses the second-form belt-shaped material; folds the second-form belt-shaped material along the second fold line; brings surfaces of the second-form belt-shaped material lying on each other into tight contact with each other; and thereby form a third-form belt-shaped material.

13. The method of claim 5, wherein
the fold line forming portion includes a recess and a ridge extending in the conveying direction, and a pair of the fold line forming rollers each including the recess and the ridge sandwich the belt-shaped material and rotate while allowing the recess and the ridge to engage with each other.
